(19) United States
(12) Patent Application Publication
(10) Pub. No.: US 2002/0009648 A1
(43) Pub. Date: Jan. 24, 2002

(54) Liquid-cooled fuel cell battery and method for operating it

(76) Inventors: Peter Buchner, Heiligenstadt (DE); Rittmar Von Helmolt, Mainz (DE)

Correspondence Address: LERNER AND GREENBERG, P.A., Post Office Box 2480, Hollywood, FL, 33022-2480, US

(21) Appl. No.: 09/899,385

(22) Filed: Jul. 5, 2001

Related U.S. Application Data
(63) Continuation of application No. PCT/DE00/00007, filed on Jan. 3, 2000.

(30) Foreign Application Priority Data
Jan. 5, 1999 (DE) 199 00 166.9

(51) Int. Cl. H01M 8/04; H01M 2/16; B32B 3/26

(52) U.S. Cl. 429/254; 429/26; 429/13; 429/144; 428/304.4

(57) ABSTRACT

A fuel cell battery is described which has a liquid cooling. The fuel cell battery has a primary cooling circuit and a secondary cooling circuit with a heat exchanger connected between them. The heat exchanger is structurally integrated into the battery, so that the length of the primary cooling circuit is minimized and the primary cooling circuit requires no external lines, i.e. lines that lead out of the battery.

### CROSS-REFERENCE TO RELATED APPLICATION

This application is a continuation of copending International Application No. PCT/DE00/00007, filed Jan. 3, 2000, which designated the United States.

### BACKGROUND OF THE INVENTION

### FIELD OF THE INVENTION

The invention relates to a fuel cell battery containing a plurality of fuel cells which form a fuel cell stack between two end plates, with feed and discharge lines for a cooling medium. In addition, the invention also relates to an operating method for the fuel cell battery that is configured this way.

The battery is cooled in the primary cooling circuit, and the coolant of the primary cooling circuit is regenerated in the secondary cooling circuit. Particularly high purity demands are imposed on the coolant of the primary cooling circuit of a fuel cell battery, since some of the coolant comes into electric contact with current-carrying components of the fuel cell battery and, in order to avoid short circuits, the coolant must have a very low conductivity, if any. Therefore, the coolant used is often distilled water or pure alcohol. To maintain the low conductivity of the coolant, the primary cooling circuit has to be made from selected, expensive materials.

Published, Non-Prosecuted German Patent Application DE 196 08 738 A1 discloses a proton-conducting electrolyte membrane (PEM) fuel cell battery in which the waste heat from the battery is used for heating purposes. On account of the purity of the coolant which is required in the fuel cell battery, the heat from the battery cannot be discharged directly via the heating water, but rather a heat exchanger is connected between the primary cooling circuit and the secondary cooling circuit.

When a fuel cell battery is used in a mobile application, the problem arises, inter alia, that two cooling circuits with a heat exchanger connected between them have to be formed, since the purity which is required of the coolant in the primary cooling circuit results in that the coolant cannot contain any additives, such as antifreeze. Accordingly, when used for mobile applications, the primary cooling circuit has to be protected from freezing, whereas antifreeze may be present in the coolant of the secondary cooling circuit.

A drawback of the known configuration for a liquid-cooled fuel cell battery is that the primary cooling circuit is connected to an external heat exchanger via external lines, i.e. lines that lead out of the fuel cell battery. Not only does this consume expensive material for the lines of the primary cooling circuit, but also there is a high demand for space, which causes problems in particular in mobile applications and unnecessarily increases the volume and weight of the fuel cell installation.

Furthermore, European Patent Application EP 0 823 743 A2 discloses a fuel cell battery in which the individual fuel cell units, in each case separated by separator plates, are stacked to form a fuel cell stack. Each of the electrode sides of the individual fuel cell unit is cooled separately, for which purpose internal cooling lines are present. In each case two adjacent electrodes of two fuel cell units are separated by a separator plate, which allows a certain degree of temperature compensation to be effected. Substantially the same configuration is described in Published Japanese Patent Applications JP 07-169484 A and JP 60-044966 A.

### SUMMARY OF THE INVENTION

It is accordingly an object of the invention to provide a liquid-cooled fuel cell battery and a method for operating it which overcome the above-mentioned disadvantages of the prior art methods and devices of this general type, in which the size of the primary cooling circuit is minimized, and in this way the cost, weight and volume of the installation are reduced.

With the foregoing and other objects in view there is provided, in accordance with the invention, a liquid-cooled fuel cell unit. The fuel cell unit contains a fuel cell stack having a plurality of fuel cells and two end plates, one of the two end plates is disposed at each end of the fuel cell stack. Feed lines and discharge lines for conducting a cooling medium are connected to the fuel cell stack. A heat exchanger and a primary cooling circuit having lines is fluidically connected to the heat exchanger and to the fuel cell stack through the lines. The lines of the primary cooling circuit extending from the fuel cell stack to the heat exchanger run inside of the fuel cell stack. A secondary cooling circuit is fluidically connected to the heat exchanger. The primary cooling circuit and the secondary cooling circuit open into the heat exchanger.

According to the invention, in the liquid-cooled fuel cell battery with the primary cooling circuit and the secondary cooling circuit, the heat exchanger is integrated in the fuel cell stack in such a manner that the lines of the primary cooling circuit from the fuel cell stack to the heat exchanger lie substantially inside the fuel cell battery.

In the method according to the invention for operating the fuel cell battery having the fuel cell stack, the primary and secondary cooling circuit, the primary cooling circuit runs substantially inside the battery. The heated and used cooling medium of the primary cooling circuit is regenerated in the heat exchanger that is integrated in the fuel cell battery. A cooling medium of the secondary cooling circuit is guided out of the fuel cell stack.

According to one configuration of the invention, the heat exchanger is a plate-type heat exchanger. The dimensions of the plates of the heat exchanger (i.e. surface area) are similar to those of the fuel cell units of the fuel cell stack of the battery and the plates are simply stacked on top of the fuel cell units in front of one of the end plates.

The heat exchanger may be made from metal, an alloy, a plastic or a ceramic, but must use a material with good thermal conductivity which does not endanger the purity of the primary coolant and, at the same time, is able to withstand the coolant of the secondary cooling circuit. It is preferable to use a metal, such as for example stainless steel, which may additionally be treated on one or both surfaces.

According to a further configuration of the invention, the coolant pump for the primary cooling circuit is flanged onto one of the end plates of the battery, so that external lines are avoided altogether in the primary cooling circuit. This also eliminates heat losses from the used primary cooling medium which otherwise occur via external lines. Therefore, the entire waste heat of the system is released to the coolant of the secondary cooling circuit in the heat exchanger.

The coolant used in the primary cooling circuit is critical in particular in terms of its conductivity, which should be as low as possible. It is preferable to use distilled water and/or pure alcohol. The coolant of the secondary cooling circuit may be any desired liquid cooling medium with any desired additives.

The heat exchanger may be connected to the fuel cell stack in various ways. According to a preferred configuration of the invention, to form the fuel cell battery the fuel cell stack and the heat exchanger are disposed on a common support.

A gas humidifier can be integrated into the fuel cell stack and the gas humidifier can be heated using waste heat from the primary cooling circuit.

Other features which are considered as characteristic for the invention are set forth in the appended claims.

Although the invention is illustrated and described herein as embodied in a liquid-cooled fuel cell battery and a method for operating it, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, cross-sectional view through a preferred embodiment of a fuel cell battery according to the invention; and

FIGS. 2 to 4 are block diagrams of preferred configurations of the invention.

### DESCRIPTION OF THE PREFERRED EMBODIMENTS

In the context of the invention, the term “fuel cell battery” is understood as meaning the entire assembly, which contains a fuel cell stack with fuel cell units and associated cooling elements, a primary cooling circuit, an integrated heat exchanger, connections for a secondary cooling circuit and end plates. In this case, an integrated gas humidifier may likewise be provided in the battery. By contrast, the term “fuel cell stack” in this context is understood as meaning only the core piece of the battery, namely the stack of fuel cell units with supply passages and cooling elements.

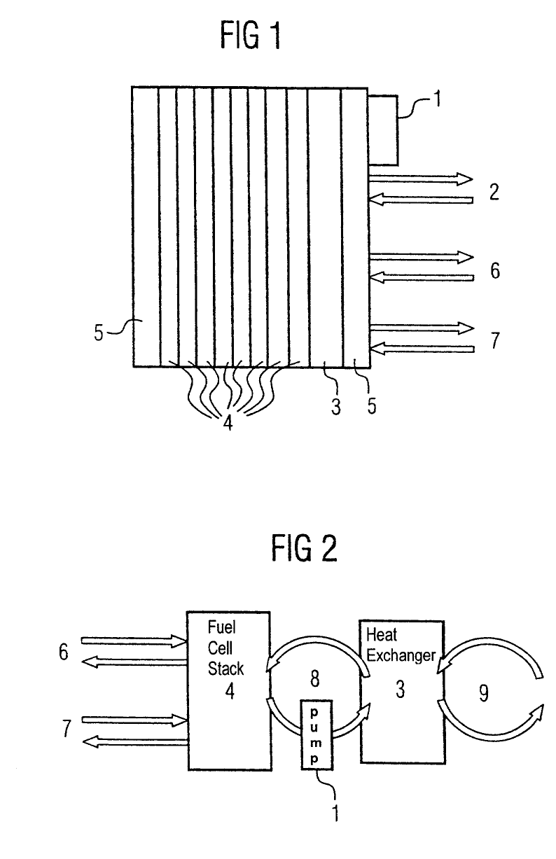

In all the figures of the drawing, sub-features and integral parts that correspond to one another bear the same reference symbol in each case. Referring now to the figures of the drawing in detail and first, particularly, to FIG. 1 thereof, there is shown a fuel cell stack which contains individual fuel cell units 4 with cooling elements. On one side of the stack is an end plate 5, and on the other side is a heat exchanger 3. In this case, the heat exchanger 3 and the fuel cell units 4 are connected by fitting the heat exchanger 3 into the fuel cell stack as a result of the heat exchanger 3 being stacked in exactly the same way as the fuel cell units 4. In an embodiment of this type, the heat exchanger 3 can easily be produced by inserting at least one additional metal sheet into the fuel cell stack. In this case, a coolant of a primary cooling circuit flows on one side of the metal sheet, while the coolant of a secondary cooling circuit flows on the other side. However, the heat exchanger 3 may also contain a large number of individual plates, which may all follow the fuel cell stack or alternatively may be disposed between the fuel cell units 4 of the stack.

The heat exchanger 3 and the fuel cell units 4 are secured as a result of the combined stack of fuel cell units 4 and the heat exchanger 3 being pressed together by common end plates

According to a further preferred embodiment, heat exchangers of conventional form may be joined to the fuel cell stack, preferably at its end plates 5, by being screwed on, pressed on or adhesively bonded, to form a battery with the integrated heat exchanger 3.

Preferably, the integrated heat exchanger 3 together with the fuel cell stack are together insulated from heat losses and/or from frost.

In FIG. 1, a coolant pump 1 of the primary cooling circuit is flanged onto the end plate 5 which adjoins the heat exchanger 3.

The end plates 5 have inlets and outlets 2, 6 and 7 for external lines. The lines form the connections of the secondary cooling circuit and the fuel and oxidant supply.

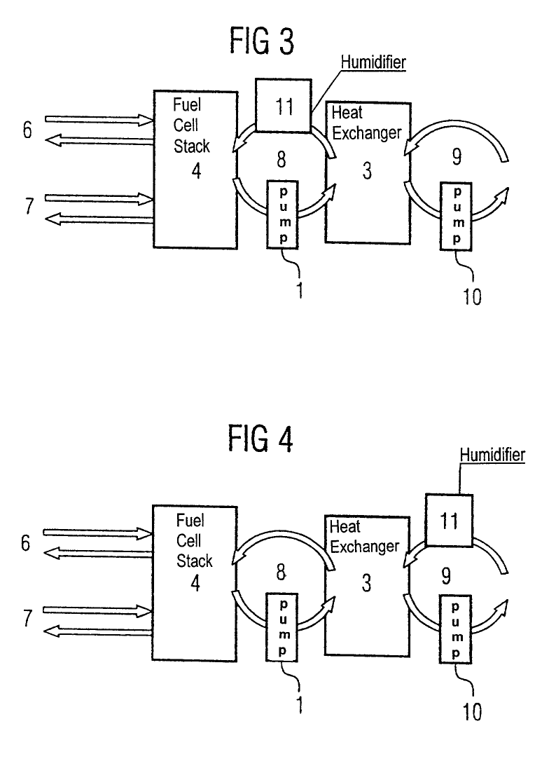

FIG. 2 shows the block diagram of another embodiment of the invention. The stack formed of the fuel cell units 4 is supplied with fuel and oxidant via the lines 6 and 7. The waste heat from the stack 4 is dissipated, via the primary cooling circuit 8 which runs via the coolant pump 1, to the heat exchanger 3 which is integrated in the fuel cell battery. A secondary cooling circuit 9 is connected to the heat exchanger 3.

It makes no difference for operation whether cooling elements are present between the fuel cell units 4 or the fuel cell units 4 are initially cooled by thermal conduction in the solid state into the outer region and by the waste heat only then being dissipated to the coolant. The axial passages (not shown in the diagrammatic illustration) which are generally present for the circulation of coolant in the fuel cell battery may be extended in such a way that the heat exchanger 3, to the extent that it is supplied from the primary cooling circuit, is also supplied through these axial passages (in this context. The term axial means perpendicular to the membrane of a fuel cell unit, i.e. in the stacking direction).

Alternatively, of course it is also possible to provide dedicated supply passages for that part of the heat exchanger 3 that is connected to the primary cooling circuit 8. The secondary cooling circuit 9 must in any case have a dedicated, closed system of lines.

FIGS. 3 and 4 show block diagrams that illustrate the interposition of a gas humidifier 11.

Generally, in the fuel cell battery having the integrated heat exchanger, the gas humidifiers 11 for the fuel gas or the oxidant are integrated, for example, in the stack. Alternatively, they are fitted externally. The humidifiers 11 may be heated via the primary cooling circuit 8 or the secondary cooling circuit 9 as desired.

FIG. 3 shows the integrated humidifier 11 that is heated by the primary cooling circuit 8. Compared to FIG. 2, FIG. 3 has simply been supplemented by the humidifier 11 and a coolant pump 10 of the secondary cooling circuit 9.

FIG. 4 corresponds to FIG. 3, with the exception of the position of the humidifier 11, which in this case is fitted externally and is heated via the secondary cooling circuit 9.

The invention relates to the fuel cell battery with liquid cooling which has the primary cooling circuit 8 and the secondary cooling circuit 9 with the heat exchanger 3 connected between them.

The heat exchanger 3 is structurally integrated in the battery, so that the primary cooling circuit 8, the material and coolant of which are expensive, runs completely inside the battery, and the primary cooling circuit 8 does not require any external lines, that is to say lines which lead out of the battery and cause corresponding heat losses.

We claim:

1. A liquid-cooled fuel cell unit, comprising:
a fuel cell stack having a plurality of fuel cells;
two end plates, one of said two end plates disposed at each end of said fuel cell stack;
feed lines and discharge lines for conducting a cooling medium connected to said fuel cell stack;
a heat exchanger;
a primary cooling circuit having lines and fluidically connected to said heat exchanger and to said fuel cell stack through said lines, said lines of said primary cooling circuit extending from said fuel cell stack to said heat exchanger run inside of said fuel cell stack; and
a secondary cooling circuit fluidically connected to said heat exchanger, said primary cooling circuit and said secondary cooling circuit open into said heat exchanger.

2. The fuel cell battery according to claim 1, wherein said heat exchanger is a plate-type heat exchanger.

3. The fuel cell battery according to claim 2, wherein said heat exchanger has a same surface area as one of said fuel cells.

4. The fuel cell battery according to claim 2, wherein said plate-type heat exchanger is disposed in said fuel cell stack and adjoins said fuel cells in front of one of said two end plates.

5. The fuel cell battery according to claim 1, wherein said primary cooling circuit has a coolant pump flanged onto one of said end plates of said fuel cell stack.

6. A method for operating a fuel cell battery having a fuel stack, a primary cooling circuit and a secondary cooling circuit, the method which comprises:
guiding the primary cooling circuit for conducting a primary cooling medium inside the fuel cell stack;
regenerating a heated and used primary cooling medium of the primary cooling circuit in a heat exchanger inside the fuel cell stack; and
guiding a secondary cooling medium of the secondary cooling circuit out of the fuel cell stack.

7. The method according to claim 6, which comprises heating a gas humidifier which is integrated in the fuel cell stack using waste heat from the primary cooling circuit.
